(19) United States
(12) Patent Application Publication
(10) Pub. No.: US 2025/0292376 A1
(43) Pub. Date: Sep. 18, 2025

(54) ELECTRONIC DEVICE FOR PROCESSING IMAGE AND OPERATING METHOD THEREOF

(71) Applicant: SAMSUNG ELECTRONICS CO., LTD., Suwon-si (KR)

(72) Inventors: Donggyu JOO, Suwon-si (KR); Dongchan KIM, Suwon-si (KR); Jinyoung HWANG, Suwon-si (KR)

(73) Assignee: SAMSUNG ELECTRONICS CO., LTD., Suwon-si (KR)

(21) Appl. No.: 19/018,385

(22) Filed: Jan. 13, 2025

Related U.S. Application Data
(63) Continuation of application No. PCT/KR2024/096854, filed on Dec. 12, 2024.

(30) Foreign Application Priority Data
Mar. 18, 2024 (KR) 10-2024-0037391

(51) Int. Cl. G06T 5/77; G06T 5/50; G06V 10/75; G06V 10/98; G06V 40/16

(52) U.S. Cl. CPC G06T 5/77; G06T 5/50; G06V 10/759; G06V 10/993; G06V 40/167; G06V 40/171; G06T 2207/10016; G06T 2207/20212; G06T 2207/30168; G06T 2207/30201

(57) ABSTRACT

Provided is a method including: obtaining a plurality of images each comprising a plurality of persons, identifying one image among the plurality of images as a base image, identifying a source image among the plurality of images based on a completion level of each of the plurality of images and a swap compatibility of each of the plurality of images, extracting a face region of a person of the plurality of persons from the source image, and generating a correction image by compositing the extracted face region on the base image, wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

### CROSS-REFERENCE TO RELATED APPLICATIONS

This application is a by-pass continuation of International Application No. PCT/KR2024/096854, filed on Dec. 12, 2024, which is based on and claims priority to Korean Patent Application No. 10-2024-0037391, filed in the Korean Intellectual Property Office on Mar. 18, 2024, the disclosures of which are incorporated by reference herein in their entireties.

### BACKGROUND

### 1. Field

The disclosure relates to an electronic device for processing images and an operating method of the electronic device, and more particularly, to an electronic device for combining valid image fragments among a plurality of images obtained through continuous capturing and an operating method of the electronic device.

### 2. Description of Related Art

Recently, due to the rapid development of communication technology, the functions of mobile terminals have gradually expanded, and accordingly, more diverse user interfaces (UIs) and various functions using the UIs have been provided. In order to increase the utility value of such mobile terminals and satisfy various needs of users, various applications that may be executed on mobile terminals have been developed.

In particular, as users' interest in photos and videos increases, most mobile terminals provide digital camera functions. In addition, users demand photos taken with digital camera functions to be of high quality and also want to take attractive “selfies.” Methods for satisfying the users' preferences, such as compensating for hand shake when shooting or enhancing photos, have been introduced. However, these are only supplementary methods of photo correction, and when a user is not satisfied with the expression or pose, reshoots will eventually be required.

### SUMMARY

According to an aspect of the disclosure, a method includes: obtaining a plurality of images each comprising a plurality of persons, identifying one image among the plurality of images as a base image, identifying a source image among the plurality of images based on a completion level of each of the plurality of images and a swap compatibility of each of the plurality of images, extracting a face region of a person of the plurality of persons from the source image, and generating a correction image by compositing the extracted face region on the base image, wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

According to an aspect of the disclosure, an electronic device includes: an input/output interface configured to receive a user input requesting processing of an image and to output an image processed according to the user input, at least one memory storing one or more instructions for processing the image, and at least one processor configured to execute the one or more instructions, wherein the one or more instructions, when executed by the at least one processor, cause the electronic device to: obtain a plurality of images each comprising an image of a person, identify one image among the plurality of images as a base image, identify a source image among the plurality of images based on a completion level of each of the plurality of images and a swap compatibility of each of the plurality of images, extract a face region of a person of the plurality of persons from the source image, and generate a correction image by compositing the extracted face region on the base image, wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

According to an aspect of the disclosure, a computer-readable recording medium has recorded thereon a program for executing the method of the disclosure on a computer.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a conceptual diagram illustrating a method of generating a correction image, according to an embodiment of the disclosure.

FIG. 2 is a flowchart illustrating a method of generating a correction image, according to an embodiment of the disclosure.

FIG. 3 is a conceptual diagram illustrating a method of evaluating a plurality of images to determine a base image or a source image among the plurality of images, according to an embodiment of the disclosure.

FIG. 4 is a flowchart illustrating a method of determining a base image among a plurality of images, according to an embodiment of the disclosure.

FIG. 5 is a flowchart illustrating a method of determining a target image among a plurality of images, according to an embodiment of the disclosure.

FIG. 6 is a flowchart illustrating a method of considering a user's preference to determine a target image, according to an embodiment of the disclosure.

FIG. 7 is a flowchart illustrating a method of considering a user's pose to determine a target image, according to an embodiment of the disclosure.

FIG. 8 is a conceptual diagram illustrating a method of filtering a plurality of images to remove a blurry image and then generating a corrected image based on the filtered plurality of images, according to an embodiment of the disclosure.

FIG. 9 is a conceptual diagram illustrating an operation of generating a three-dimensional (3D) face model based on an image including the first person, according to an embodiment of the disclosure.

FIG. 10 is a flowchart illustrating a method of correcting a face region of a base image based on a 3D face model, according to an embodiment of the disclosure.

FIG. 11 is a conceptual diagram illustrating a method of rotating a pose of a face region based on a 3D face model, according to an embodiment of the disclosure.

FIG. 12 is a conceptual diagram illustrating a method of changing the illumination of a face region based on a 3D face model, according to an embodiment of the disclosure.

FIG. 13 is a conceptual diagram illustrating a method of correcting an occluded area in a face region based on a 3D face model, according to an embodiment of the disclosure.

FIG. 14 is a conceptual diagram illustrating a method of reflecting an object on a finally corrected image when an object is present in a face region of a base image, according to an embodiment of the disclosure; and

FIG. 15 is a block diagram illustrating a configuration of an electronic device according to an embodiment of the disclosure.

### DETAILED DESCRIPTION

In describing the disclosure, technical aspects well known in the art of the disclosure and not directly relevant to the disclosure will not be described. Also, the terms described below are defined by considering the functions in the disclosure and may be changed according to an intention of a user or operator, a precedent, etc. Thus, the terms shall be defined based on the content throughout the specification.

Likewise, some of components in the accompanying drawings are exaggerated, omitted, or schematically illustrated. Also, the size of each component does not completely reflect the actual size. In each drawing, the same reference numeral is assigned to the same or corresponding component.

The advantage or characteristics of the disclosure and the method of achieving the same will be apparent with reference to embodiments described in detail below together with the accompanying drawings. However, the disclosure is not limited to the embodiments disclosed hereinafter and may be realized in various different forms. The disclosed embodiments are provided to fully disclose the disclosure and completely convey the scope of the disclosure to one of ordinary skill in the art. An embodiment of the disclosure may be defined according to the claims. The same reference numerals indicate the same components throughout the specification. Also, in describing an embodiment of the disclosure, when it is determined that a detailed description of a relevant function or component may unnecessarily obscure the gist of the disclosure, the detailed description is omitted.

Terms such as “unit”, “module”, “member”, and “block” may be embodied as hardware or software. As used herein, a plurality of “units”, “modules”, “members”, and “blocks” may be implemented as a single component, or a single “unit”, “module”, “member”, and “block” may include a plurality of components.

It will be understood that when an element is referred to as being “connected” with or to another element, it can be directly or indirectly connected to the other element, wherein the indirect connection may include “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

As used herein, the expressions “at least one of a, b or c” and “at least one of a, b and c” indicate “only a,” “only b,” “only c,” “both a and b,” “both a and c,” “both b and c,” and “all of a, b, and c.”

It will be understood that, although the terms “first”, “second”, “third”, etc., may be used herein to describe various elements, is the disclosure should not be limited by these terms. These terms are only used to distinguish one element from another element.

As used herein, the singular form “a”, “an” and “the” are intended to include the plural expressions as well, unless the context clearly indicates otherwise.

With regard to any method or process described herein, an identification code may be used for the convenience of the description but is not intended to illustrate the order of each step or operation. Each step or operation may be implemented in an order different from the illustrated order unless the context clearly indicates otherwise. One or more steps or operations may be omitted unless the context of the disclosure clearly indicates otherwise.

According to an embodiment of the disclosure, each of block of each flowchart, and combinations of the flowcharts, may be performed by computer program instructions. The computer program instructions may be loaded on a processor of a general-purpose computer, a special-use computer, or other programmable data processing device, and the instructions performed by the processor of the computer or the other programmable data processing device may generate a means for performing the functions described in the flowchart block(s). The computer program instructions may be stored in a computer-usable or computer-readable memory, which may be oriented for a computer or other programmable data processing device, in order to realize a function in a specific method, and the instructions stored in the computer-usable or computer-readable memory may also generate a manufacturing item including an instruction means for performing the functions described in the flowchart block(s). The computer program instructions may also be loaded on a computer or other programmable data processing device.

Furthermore, each block in the flowchart may represent a part of a module, segment, or a code including one or more executable instructions for performing (a) specific logic function(s). According to an embodiment of the disclosure, the functions described with respect to the blocks may also be performed without following the order. For example, two blocks illustrated in succession may be executed substantially concurrently or may sometimes be executed in a reverse order, depending on the functions involved therein.

The term “unit” used in an embodiment of the disclosure may indicate a software component or a hardware component such as a field programmable gate array (FPGA) or an application specific integrated circuit (ASIC), and the “unit may perform a certain role. However, the “unit” is not limited to indicate software or hardware. The “unit” may be configured to be located in a storage medium which may be addressed or may be configured to play one or more processors. According to an embodiment of the disclosure, a “unit” may include components, such as software components, object-oriented software components, class components, and task components, processes, functions, attributes, procedures, sub-routines, segments of a program code, drivers, firmware, a microcode, a circuit, data, a database, data structures, tables, arrays, and variables. Functions provided through a certain component or a certain “unit” may be combined to reduce the number of functions or may be divided into additional components. Also, according to an embodiment of the disclosure, a “unit” may include one or more processors.

Hereinafter, the meanings of terms used in the disclosure will be described.

A corrected image may be generated from a plurality of images according to one or more embodiments of the disclosure described below.

In the disclosure, a base image may be an image selected as a base from among a plurality of images. The base image may be selected as an image requiring minimal correction from among the plurality of images. For example, a method according to an embodiment of the disclosure may include replacing a portion of the base image with an area of another image, based on the base image. The term “base image” is used only to refer to an image used as a base for image processing, and may be replaced with various terms, such as best image, best take, best cut, best shot, reference image, and base image.

In the disclosure, a source image may be an image including an area where a portion of the base image is to be replaced from among a plurality of images. The source image includes an area corresponding to a portion of the base image, and a corresponding area of the source image is more advantageous in satisfying the user than a corresponding area of the base image in terms of various factors, such as aesthetic viewpoint, user's pose preference, and clarity. The source image is used only in the sense of a source for extracting a face region, and may be replaced with various terms, such as original image, swap image, replacement image, and substitution image.

In the disclosure, the completion level of shooting refers to the degree to which an image is well captured. From the perspective of a shooting subject, the completion level of shooting may refer to the degree to which the person included in the image is well shot, that is, photographed. For example, the completion level of shooting may be determined for one person among a plurality of persons included in the image. For one image, a plurality of completion levels of shooting, such as the completion level of shooting of a first person, the completion level of shooting of a second person, and the completion level of shooting of a third person, may be determined. In addition, the completion level of shooting may be determined by considering factors regarding how the person included in the image is shot. For example, the completion level of shooting may be determined by considering not only the facial expression of the person, but also aesthetic viewpoints, such as whether the person included in the image has their eyes closed, whether the person's gaze is directed toward the camera, whether the person's face is shaded, or whether the person's face is occluded by an object.

In the disclosure, the aesthetic score refers to a score obtained by numerically quantifying the completion level of shooting of an image. Similar to the completion level of shooting, the aesthetic score may be determined for one person among a plurality of persons included in the image, and a plurality of aesthetic scores, such as the aesthetic score of the first person, the aesthetic score of the second person, and the aesthetic score of the third person, may be determined for one image.

In the disclosure, the aesthetic score is described by dividing into a first aesthetic score and a second aesthetic score. The first aesthetic score refers to an aesthetic score used in a method of determining a base image. The first aesthetic score refers to a score obtained by numerically quantifying the completion level of shooting of face regions of a plurality of persons with respect to each of the plurality of images. That is, the first aesthetic score refers to a score determined for any person with respect to a plurality of images. The first aesthetic score may be a score determined for all persons included in the plurality of images. The second aesthetic score refers to an aesthetic score used in a method of determining a source image for replacing the face region of the first person. The second aesthetic score refers to a score obtained by numerically quantifying the completion level of shooting of the face region of the first person with respect to each of the plurality of images. That is, the second aesthetic score refers to a score determined for the first person selected for the plurality of images. The second aesthetic score refers to a score determined for the first person included in the plurality of images.

However, the first aesthetic score and the second aesthetic score may be compatibility scores that may be calculated in the same manner, and are only terms that are distinguished from each other for the convenience of description.

In the disclosure, swap compatibility refers to swap compatibility between face regions of the same person included in two images. In this case, swap refers to a correction, in which the face region of the first person in the first image is replaced with the face region of the first person in the second image, in the first and second images including the first person. The swap compatibility may refer to the degree to which the swap may be appropriately performed according to the compatibility between a swapped face region and a surrounding area thereof.

From the perspective of a shooting subject, the swap compatibility may refer to the degree to which the swap between face regions may be appropriately performed for the person included in the image. For example, the swap compatibility may be determined for one person among a plurality of persons included in the image. Regarding whether a face region included in one image may be replaced with a face region included in the base image, a plurality of swap compatibilities, such as the swap compatibility of the first person, the swap compatibility of the second person, and the swap compatibility of the third person, may be determined.

In the disclosure, the compatibility score refers to a score obtained by numerically quantifying the swap compatibility of the image. As with the swap compatibility, the compatibility score may be determined for one of the plurality of persons included in the image, and a plurality of compatibility scores, such as the compatibility score of the first person, the compatibility score of the second person, and the compatibility score of the third person, may be determined for one image.

In the disclosure, the compatibility score may be described by dividing into a first compatibility score and a second compatibility score. The first compatibility score refers to a compatibility score used in a method of determining a base image. The first compatibility score refers to a score obtained by numerically quantifying the swap compatibility between a face region pair of a target person included in an image pair, the image pair including two images among a plurality of images. In other words, the first compatibility score refers to a score determined for any person with respect to the image pair. The first compatibility score may be a score determined for each of all persons included in a plurality of images. The second compatibility score refers to a compatibility score used in a method of determining a source image for replacing the face region of the first person. The second compatibility score refers to a score obtained by numerically quantifying the swap compatibility between a face region pair of the first person included in an image pair. That is, the second compatibility score refers to a score determined for the first person with respect to the image pair. The second compatibility score refers to a score determined for the first person included in a plurality of images.

However, the first compatibility score and the second compatibility score may be compatibility scores that may be calculated in the same manner, and are merely terms that are distinguished from each other for the convenience of description.

In the disclosure, a feature point refers to a point that is distinguished from a surrounding background or is identifiable in an image, and corresponds to a major point of the body. For example, a feature point for a hand may include points corresponding to a plurality of joints included in the hand. The feature point may be expressed as a three-dimensional position coordinate value, which is position information about the x-axis, y-axis, and z-axis of a major point of the body.

In the disclosure, the feature point is described by dividing into a base feature point and a source feature point. The base feature point refers to a feature point extracted from a base image. The base feature point refers to a feature point for a person in the base image. The source feature point refers to a feature point extracted from a source image. The source feature point refers to a feature point for a person in the source image.

In the disclosure, blurriness may refer to the degree of blurring in which details of an image are smoothly blurred or faded. The blurring may occur due to reasons, such as lack of focus (defocus), rapid movement of the subject during shooting (motion blur), and low resolution or excessive compression of the image (low-resolution blur).

Below, embodiments of the disclosure are described in detail with reference to the attached drawings so that those skilled in the art may practice the embodiments of disclosure. However, the disclosure may be implemented in various different forms and is not limited to the embodiments of the disclosure described herein. In addition, in order to clearly describe the disclosure in the drawings, parts unrelated to the description are omitted, and similar parts are given similar drawing reference numerals throughout the specification. In addition, the drawing reference numerals used in each drawing are only for describing each drawing, and different drawing reference numerals used in different drawings are not intended to represent different elements. The disclosure will be described in detail below with reference to the attached drawings.

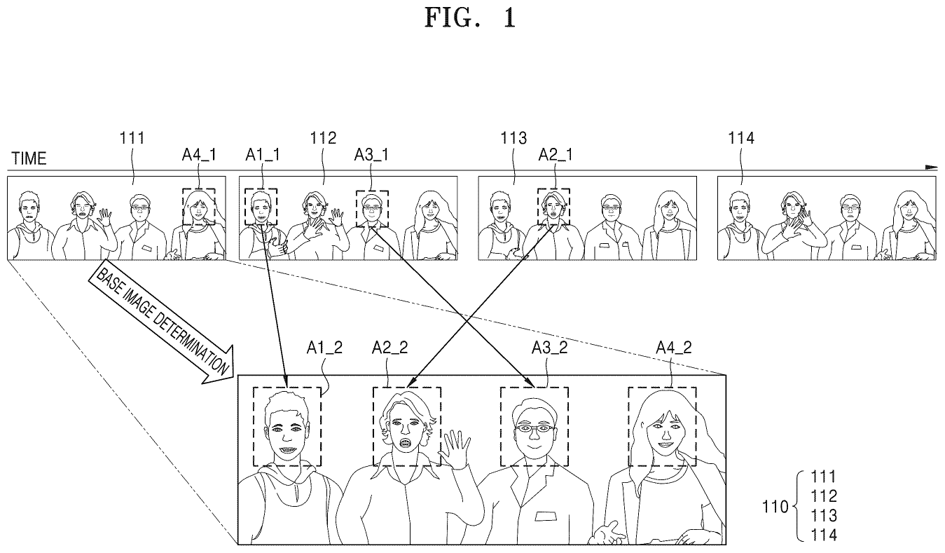

FIG. 1 is a conceptual diagram illustrating a method of generating a correction image, according to an embodiment of the disclosure.

Referring to FIG. 1, an electronic device may obtain a plurality of images 110 including first to fourth images 111, 112, 113, and 114.

The plurality of images 110 may be images continuously captured over a set period of time. The plurality of images 110 may include an image sequence, which refers to a series of image sets arranged in order over time. For example, the plurality of images 110 may include at least one of an image set captured over a set period of time, a motional image including images captured over a set period of time, or a video.

In an embodiment of the disclosure, the plurality of images 110 may each refer to a group photo including a plurality of persons. The plurality of images 110 may each be an image including face regions of the plurality of persons. The plurality of images 110 may each be an image including face regions of four persons, but the disclosure is not limited to a specific number of persons.

In an embodiment of the disclosure, the plurality of images 110 may each include a group photo including not only persons but also a plurality of living things. The plurality of images 110 may each include an image including face regions of the plurality of living things. For example, at least one of the plurality of images 110 may be an image including a face of a dog, and an image processing method according to an embodiment of the disclosure may perform an operation of replacing the face region of the dog in a base image with the face region of the dog in a source image. However, the disclosure will be described with a focus on a method of replacing the face region of a person.

In an embodiment of the disclosure, the plurality of images 110 may be images obtained by capturing appearances of a plurality of persons changing over time. Over time, some of the plurality of images 110 may be images obtained by shooting at least one of the plurality of persons. For example, one image of the plurality of images 110 may include all of the plurality of persons, while another image of the plurality of images 110 may include two persons among the plurality of persons.

Each person included in the plurality of images 110 may be shot differently for each image, such as taking a different pose or making a different expression over time. In particular, for the face region, each person included in the plurality of images 110 may be shot with their eyes closed, occluded by an external object, or looking in a wrong direction. This may cause the user to be dissatisfied with the captured image.

In an embodiment of the disclosure, the electronic device may identify one image of the plurality of images 110 as a base image. For example, the electronic device may determine the first image 111 as a base image.

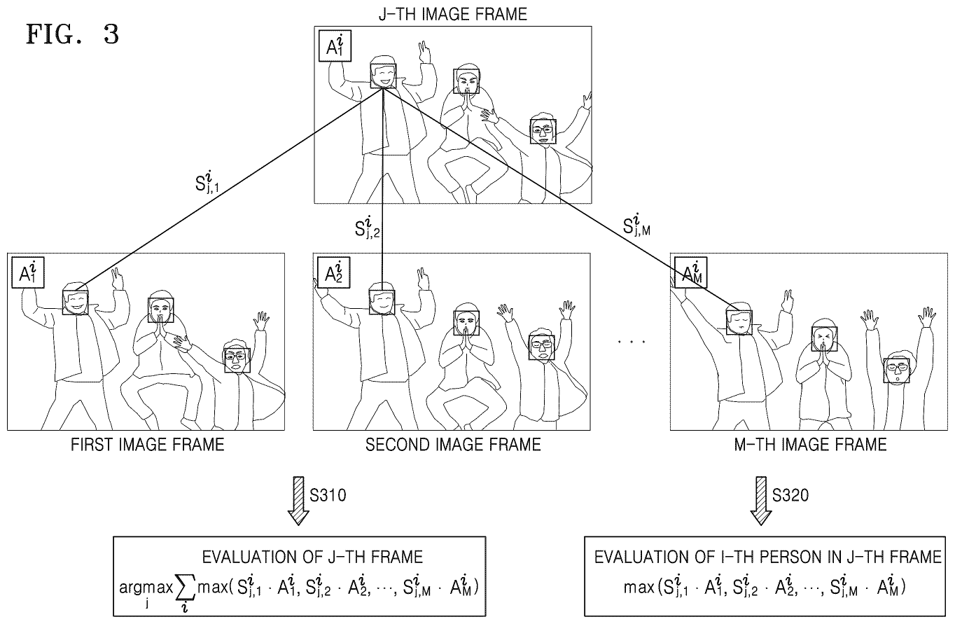

For example, unlike as illustrated in FIG. 1, the electronic device may determine the fourth image 114 obtained last from among the plurality of images 110 as the base image. In another example, the electronic device may determine, as the base image, the first image 111 with the highest degree of completion from among the plurality of images 110. The electronic device may consider the completion level of shooting and the swap compatibility, which will be described according to an embodiment of the disclosure described below, to determine the degree of completion, and a description related thereto will be described below using FIG. 3.

In an embodiment of the disclosure, the electronic device may determine any one image among the plurality of images 110 as a source image to replace a face region A1_2 of the first person in the base image.

The base image may be a group photo including a plurality of persons. The base image may be an image including the face regions of the plurality of persons. The plurality of persons included in the base image may include the first person. The first person may be a person selected for convenience of description.

In an embodiment of the disclosure, the electronic device may determine, as a source image for the first person, a second image 112 among the plurality of images 110 including the first person. The source image for the first person may refer to a source image selected to replace the face region A1_2 of the first person in the base image.

In an embodiment of the disclosure, the electronic device may extract a face region A1_1 of the first person included in the source image for the first person. For example, the electronic device may extract the face region A1_1 of the first person from the second image 112.

In an embodiment of the disclosure, the electronic device may replace the face region A1_2 of the first person in the base image with the face region A1_1 of the first person in the source image. The face region A1_2 of the first person in the base image may be replaced with the face region A1_1 of the first person in the source image. The face region A1_1 of the first person in the source image may also be composited on the face region A1_2 of the first person in the base image. The face region A1_1 of the first person in the source image may also be composited by overlapping the face region A1_2 of the first person in the base image. A method of replacing the face region A1_2 of the first person in the base image with the face region A1_1 of the first person in the source image does not limit the technical idea of the disclosure.

For reference, only a method of replacing the face region of a person in the base image with the face region of a person in the source image based on the first person has been described, and a method of replacing the face region of a person in the base image with the face region of a person in the source image with respect to other persons except the first person in the plurality of images is also the same as the method, and thus, the redundant description is briefly given or omitted.

For example, the electronic device may determine, as a source image for the second person, the third image 113 among the plurality of images 110 including the second person. The electronic device may extract a face region A2_1 of the second person included in the third image 113, which is the source image for the second person. The electronic device may replace a face region A2_2 of the second person in the base image with the face region A2_1 of the second person in the source image.

In an embodiment of the disclosure, the first image 111 among the plurality of images 110 including the fourth person may be determined as a source image for the fourth person. As illustrated in FIG. 1, because the first image 111 is determined as the base image and the source image for the fourth person, the electronic device may maintain a face region A4_2 of the fourth person in the base image. The face region A4_2 of the fourth person in the base image may be the same as the face region A4_1 of the fourth person in the first image 111, which is the source image for the fourth person. That is, when the base image among the plurality of images 110 is determined as the source image for the fourth person, the operation of replacing the face region of the fourth person is unnecessary and may not be performed.

In an embodiment of the disclosure, the electronic device may determine the source image for each person, such as the source image for the first person, the source image for the second person, or the source image for the third person, among the plurality of images 110. The source image for the first person and the source image for the second person may be different from each other. For example, as illustrated in FIG. 1, the source image for the first person may be determined as the second image 112, and the source image for the second person may be determined as the third image 113.

In an embodiment of the disclosure, the electronic device may generate a correction image 120 by replacing face regions A1_2, A2_2, and A3_2 of a plurality of persons in a base image with face regions A1_1, A2_1, and A3_1 in a source image for each person.

For example, the generated correction image 120 may be an image in which the face region of each included person is replaced based on the first image 111, which is a base image. The correction image 120 may be an image in which the face region A1_2 of the first person is replaced with the face region A1_1 of the first person extracted from the second image 112, which is a source image for the first person. The correction image 120 may be an image in which the face region A2_2 of the second person is replaced with the face region A2_1 of the second person extracted from the third image 113, which is a source image for the second person. The correction image 120 may be an image in which the face region A3_2 of the third person is replaced with the face region A3_1 of the third person extracted from the second image 112, which is a source image for the third person. The face region A4_2 of the fourth person in the correction image 120 may be an image in which the face region A4_1 of the fourth person in the first image 111 is maintained because the first image 111, which is the source image for the fourth person, is also the base image.

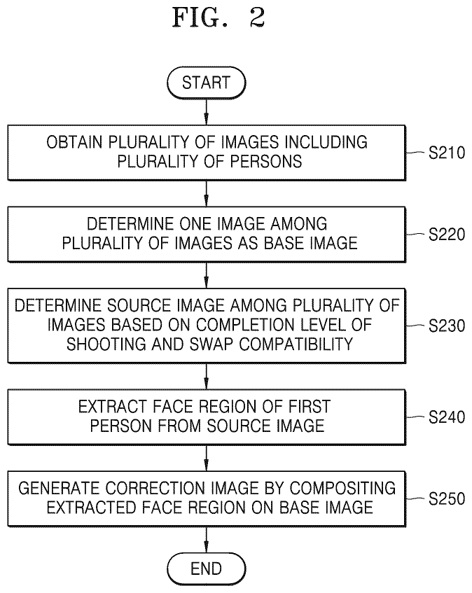

FIG. 2 is a flowchart illustrating a method of generating a correction image, according to an embodiment of the disclosure.

Referring to FIG. 2, in operation S210, an electronic device may obtain a plurality of images including a plurality of persons.

In an embodiment of the disclosure, the electronic device may include a camera module and may capture the plurality of images including the plurality of persons by using the camera module. The electronic device may obtain an image sequence by capturing the plurality of images over a set period of time. The electronic device may obtain, for example, a video, a motional image, etc.

In an embodiment of the disclosure, the electronic device may obtain the plurality of images through communication with a separate server. The plurality of images may be a plurality of images continuously captured during a set period of time.

In operation S220, the electronic device may identify one image among the plurality of images as a base image.

In an embodiment of the disclosure, the electronic device may determine a last captured image among the plurality of continuously captured images as a base image. Alternatively, the electronic device may determine a first captured image among the plurality of continuously captured images as a base image. The electronic device may identify one image among the plurality of images as a base image.

In operation S230, the electronic device may identify a source image among the plurality of images based on the completion level of shooting and the swap compatibility.

In an embodiment of the disclosure, the completion level of shooting may refer to the completion level of shooting of the face regions of the first person included in the plurality of images. The completion level of shooting may refer to the degree of evaluation as to whether the face of the first person is well shot. The completion level of shooting may be evaluated for one person among a plurality of persons included in one image, and the electronic device may obtain a plurality of completion levels of shooting for a plurality of images.

The completion level of shooting may be determined by considering factors regarding how the person included in the image is shot. For example, the completion level of shooting may be determined by considering not only the facial expression of the person, but also aesthetic viewpoints, such as whether the person included in the image has their eyes closed, whether the person's gaze is directed toward the camera, whether the person's face is shaded, or whether the person's face is occluded by an object.

In an embodiment of the disclosure, the swap compatibility may refer to the degree of evaluation as to whether the face of the first person included in a plurality of images may be naturally replaced with the face region of the first person included in the base image. The swap compatibility may be evaluated for one person among a plurality of persons included in one image, and the electronic device may obtain a plurality of swap compatibilities for a plurality of images and a plurality of persons.

In order to identify a source image, the swap compatibility may be determined by comparing the face of a person included in one image with the face of the same person included in the base image. For example, the swap compatibility may be determined by considering the direction, angle, and perspective of the face of the person.

In an embodiment of the disclosure, in order to determine the source image, the swap compatibility may be determined by comparing the person included in one image with the same person included in the base image. For example, the swap compatibility may be determined by considering the direction, angle, and perspective of the face of the person, as well as the pose, direction, angle, and perspective of the body connected to the face of the person.

In an embodiment of the disclosure, the electronic device may identify a source image among the plurality of images based on the completion level of shooting and the swap compatibility. The electronic device may identify a source image for the first person from among the plurality of images based on the completion level of shooting and swap compatibility of the plurality of images for the first person. The source image for the first person may refer to a source image for replacing the face region of the first person in the base image.

In operation S240, the electronic device may extract a face region of the first person from the source image. In operation S250, the electronic device may generate a correction image by compositing the extracted face region on the base image.

In an embodiment of the disclosure, the electronic device may identify a source image for the first person. The electronic device may extract a face region of the first person from the source image for the first person. The electronic device may composite the extracted face region of the first person on the face region of the first person in the base image. The face region of the first person in the base image may be replaced by the face region of the first person extracted from the source image for the first person. By replacing the face region of the first person on the base image, the electronic device may obtain a correction image.

FIG. 3 is a conceptual diagram illustrating a method of evaluating a plurality of images to determine a base image or a source image among a plurality of images, according to an embodiment of the disclosure.

For convenience of description, descriptions that are the same as those given with reference to FIG. 1 are simplified or omitted.

Referring to FIG. 3, the electronic device may obtain a plurality of images. Any j-th image frame among the plurality of images may be selected. The j-th image frame is selected only for convenience of description, and the electronic device may correspond each of the plurality of images to the j-th image frame and obtain each aesthetic score and compatibility score based on the j-th image frame.

In operation S310, the electronic device may determine any one image among the plurality of images as a base image. The electronic device may determine the base image based on the aesthetic score and the compatibility score.

With regard to the calculation of the aesthetic score, in an embodiment of the disclosure, the electronic device may obtain an aesthetic score, which is a score obtained by numerically quantifying the completion level of shooting of the face region of any i-th person in the j-th image frame. The aesthetic score, which is a score obtained by numerically quantifying the completion level of shooting of the face region of any i-th person in the j-th image frame, may be expressed by, for example, Equation 1.

$${A}_{j}^{i} \qquad Equation 1$$

In Equation 1, j may be a natural number that distinguishes a plurality of images obtained by the electronic device. For example, the aesthetic score for the i-th person in the first image frame may be expressed as A₁ⁱ and the aesthetic score for the i-th person in the second image frame may be expressed as A₂ⁱ.

In Equation 1, i may be a natural number that distinguishes a plurality of persons included in the plurality of images obtained by the electronic device. For example, the aesthetic score for the first person in the j-th image frame may be expressed as Aⱼ¹, and the aesthetic score for the second person in the j-th image frame may be expressed as Aⱼ².

In an embodiment of the disclosure, the aesthetic score may refer to a score obtained by numerically quantifying the completion level of shooting of the face region of each of the plurality of persons with respect to each of the plurality of images. The aesthetic score may refer to a score obtained by numerically quantifying the evaluation of whether the face region is well shot.

The aesthetic score may be determined by evaluating factors, such as whether a shot (photographed) target person has their eyes closed, whether the target person is blurredly shot due to large motion, whether hands or hair occlude the face, whether the expression is appropriate, and whether the pose of the face is facing forward.

For example, when the shot (photographed) target person has their eyes closed, the aesthetic score may be evaluated low. When the target person has large motion and thus is blurredly shot, the aesthetic score may be evaluated low. When the face is occluded by hands or hair, the aesthetic score may be evaluated low. When the target person has a smiling expression, the aesthetic score may be evaluated high. When the user prefers a blank expression based on their personal preference, the aesthetic score may be set to be evaluated high when the target person has a blank expression. When the target person's face is facing forward, the aesthetic score may be evaluated high. When the user prefers a side face based on their personal preference, the aesthetic score may be set to be evaluated high when the target person faces the side.

In an embodiment of the disclosure, the aesthetic score may refer to a score obtained by numerically quantifying the completion level of shooting of the face regions of a plurality of persons with respect to each of the plurality of images, based on the relationship between the plurality of persons. The plurality of images may be group photos of the plurality of persons, and the aesthetic score may refer to a score obtained by numerically quantifying the evaluation of whether the faces of the plurality of persons are well shot and matched.

For example, the aesthetic score may be determined based on the gaze directions of the plurality of persons by highly evaluating the fact that the gaze directions of the plurality of persons in the plurality of images are the same or similar. The aesthetic score may be highly evaluated when the gazes of the plurality of persons are directed toward a camera in the same way.

In another example, the aesthetic score may be determined based on the expressions or motions of the plurality of persons by highly evaluating the fact that the expressions or motions of the plurality of persons in the plurality of images are the same or similar. The aesthetic score may be highly evaluated when the plurality of persons make the same smiling or crying expressions or make similar motions.

In an embodiment of the disclosure, the electronic device may obtain the aesthetic score for the i-th person of the j-th image frame by considering the individual's preference.

In an embodiment of the disclosure, the electronic device may obtain an image of the i-th person from a plurality of images and store the obtained image in a memory. The memory may include a cluster that stores data having the same attribute. The electronic device may extract the image of the i-th person from the plurality of images and store a group of extracted images in the cluster.

In an embodiment of the disclosure, the electronic device may obtain a personal preference for the i-th person based on a group of images of the i-th person stored in the cluster. The personal preference may be determined depending on a frequency or rate of the appearance of the i-th person, based on the group of images of the i-th person.

For example, in the group of images of the i-th person, the higher the rate of the appearance of the i-th person resting his chin, the more it may be evaluated that the i-th person prefers the appearance of resting his chin. In another example, in the group of images of the i-th person, the higher the rate of the appearance of the i-th person looking at the sky, the more it may be evaluated that the i-th person prefers the appearance of looking at the sky. In another example, in the group of images of the i-th person, the lower the ratio of the i-th person making a frowning expression, the more it may be evaluated that the i-th person does not prefer the frowning expression.

In an embodiment of the disclosure, the electronic device may additionally obtain an external image including the i-th person, and the external image including the i-th person may be stored in the cluster. The external image may include images other than the plurality of images continuously captured during a set period of time. For example, the electronic device may obtain the external image from a server. The electronic device may evaluate personal preference from the external image including the i-th person, and may obtain an aesthetic score for the i-th person in the j-th image frame based on the evaluated personal preference.

With regard to the calculation of the compatibility score, in an embodiment of the disclosure, the electronic device may obtain a compatibility score, which is a score obtained by numerically quantifying the swap compatibility between the face region of the i-th person included in any j-th image frame and the face region of the i-th person included in an M-th image frame. The compatibility score, which is a score obtained by numerically quantifying the swap compatibility between the face region of the i-th person included in the j-th image frame and the face region of the i-th person included in the M-th image frame, may be expressed by, for example, Equation 2.

$${S}_{j , M}^{i} \qquad Equation 2$$

In Equation 2, j and M may be natural numbers that distinguish a plurality of images obtained by the electronic device. For example, the compatibility score between the face region of the i-th person included in the 1st image frame and the face region of the i-th person included in the M-th image frame may be expressed as S_{1,M}ⁱ, and the compatibility score between the face region of the i-th person included in the 2nd image frame and the face region of the i-th person included in the M-th image frame may be expressed as S_{2,M}ⁱ.

Because two image frames are compared to calculate the compatibility score, the two image frames are distinguished as the j-th image frame and the M-th image frame, respectively, and M may be a variable having the same meaning as j.

However, M may refer to the number of a plurality of images obtained by the electronic device, and j may refer to one of the natural numbers between 1 and M. That is, the j-th image frame may refer to any image frame selected between the 1st image frame and the M-th image frame.

In Equation 2, i may be a natural number that distinguishes a plurality of persons included in the plurality of images obtained by the electronic device. For example, the compatibility score between the face region of the first person included in the j-th image frame and the face region of the first person included in the M-th image frame may be expressed as S_{j,M}¹, and the compatibility score between the face region of the second person included in the j-th image frame and the face region of the second person included in the M-th image frame may be expressed as S_{j,M}².

In an embodiment of the disclosure, the compatibility score may be a score obtained by numerically quantifying the swap compatibility between a face region pair of one person of the plurality of persons included in an image pair, the image pair including two images among a plurality of images. The compatibility score may refer to a score obtained by numerically quantifying the evaluation of whether the face region of the first person included in a reference image may be naturally replaced when replaced with the face region of the first person included in another image. The compatibility score may be determined by considering the relative swap compatibility between the face regions included in the two images of the image pair.

In an embodiment of the disclosure, the compatibility score may be determined by considering the pose of a target person. The pose of the target person may include at least one of the pose of the face of the target person or the pose of the body of the target person. The pose of the face of the target person may be determined by considering the direction, angle, perspective, etc. of the face. The pose of the body of the target person may be determined based on the direction, angle, motion of arms and legs, perspective, etc. of the body. The electronic device may obtain the pose of the target person through an accelerometer or a gyroscope, but the type of sensor does not limit the technical idea of the disclosure.

For example, the more similar a face direction of the first person included in the reference image and a face direction of the first person included in another image are to each other, the higher the compatibility score may be evaluated. The more similar the size of the face of the first person included in the reference image and the size of the face of the first person included in another image are to each other in terms of perspective, the higher the compatibility score may be evaluated. The more similar a body direction of the first person included in the reference image and a body direction of the first person included in another image are to each other, the higher the compatibility score may be evaluated. The more similar the arrangement of the neck of the first person included in the reference image and the arrangement of the neck of the first person included in another image are to each other, the higher the compatibility score may be evaluated. The compatibility score may be calculated by comprehensively evaluating the facial pose and body pose of the target person.

In an embodiment of the disclosure, the electronic device may obtain a compatibility score between the face region of the i-th person included in the j-th image frame and the face region of the i-th person included in the M-th image frame based on a feature point related to a major position of the body of the target person.

In an embodiment of the disclosure, the electronic device may extract a first feature point related to the major position of the body of the i-th person from the j-th image frame. The electronic device may extract a second feature point related to the major position of the body of the i-th person from the M-th image frame. The electronic device may obtain a compatibility score related to whether the face of the i-th person in the j-th image frame may be suitably replaced with the face of the i-th person in the M-th image frame by comparing the first feature point with the second feature point. As a result, the electronic device may obtain compatibility scores regarding whether faces of any person in an image pair (ok?) may be replaced with each other, the image pair including two images among a plurality of images.

In an embodiment of the disclosure, the feature point may include coordinate value data corresponding to the major position of the body of the target person. The electronic device may determine the direction, angle, and perspective of the face of the target person by considering the feature point. Based on the determined direction, angle, and perspective of the face, the electronic device may calculate a compatibility score regarding whether the face of the i-th person in the j-th image frame may be suitably replaced with the face of the i-th person in the M-th image frame. Based on the determined direction, angle, and perspective of the face, the electronic device may calculate the compatibility score by comparing the first feature point corresponding to the face of the i-th person in the j-th image frame with the second feature point corresponding to the face of the i-th person in the M-th image frame.

In an embodiment of the disclosure, the feature point may correspond to the major position in the face of the body of the target person. For example, the major position of the feature point may include the eyes, nose, mouth, chin, and cheekbone protrusions.

For example, the electronic device may compare the position of the face of the i-th person by comparing the first feature point corresponding to the nose of the face of the i-th person in the j-th image frame with the second feature point corresponding to the nose of the face of the i-th person in the M-th image frame. The electronic device may compare the position and perspective of the face of the i-th person by further comparing the first feature point corresponding to the mouth of the face of the i-th person in the j-th image frame with the second feature point corresponding to the mouth of the face of the i-th person in the M-th image frame. The electronic device may compare the position, direction, angle, and perspective of the face of the i-th person by further comparing the first feature point corresponding to the eyes of the face of the i-th person in the j-th image frame with the second feature point corresponding to the eyes of the face of the i-th person in the M-th image frame.

The electronic device may compare the position, direction, angle, and perspective of the face of the i-th person by comparing a plurality of first feature points corresponding to the i-th person in the j-th image frame with a plurality of second feature points corresponding to the i-th person in the M-th image frame, respectively, and may calculate a compatibility score.

In an embodiment of the disclosure, the feature point may correspond to the major position in the body of the target person. For example, the major position of the feature point may include a plurality of positions corresponding to the neck connected to the face, as well as the eyes, nose, mouth, chin, and cheekbone protrusions within the face, and a plurality of positions corresponding to the chest, stomach, and collarbone for determining the direction of the upper body and the hands, elbows, and shoulders for determining the pose of the upper body.

For example, the electronic device may compare how connection points between the neck and face of the i-th person are arranged by comparing the first feature point corresponding to a connection point between the neck and face of the i-th person in the j-th image frame with the second feature point corresponding to a connection point between the neck and face of the i-th person in the M-th image frame. The connection point between the neck and the face may correspond to a single feature point, but a part where the neck and the face are connected to each other may be defined as a line or a plane and correspond to a plurality of feature points. The electronic device may determine whether the face of the i-th person in the j-th image frame may be naturally replaced with the face of the i-th person in the M-th image frame by comparing the first feature point with the second feature point. Specifically, the more similar the arrangement of the first feature point and the arrangement of the second feature point, the first and second feature points corresponding to the connection points between the neck and the face, are to each other, the easier it may be to replace the face of the i-th person in the j-th image frame with the face of the i-th person in the M-th image frame and the higher the compatibility score may be calculated.

In another example, the electronic device may compare the direction of the upper body of the i-th person by comparing the first feature point corresponding to the upper body of the i-th person in the j-th image frame with the second feature point corresponding to the upper body of the i-th person in the M-th image frame. The feature point corresponding to the upper body may include a plurality of feature points. The electronic device may determine whether the face of the i-th person in the j-th image frame may be naturally replaced with the face of the i-th person in the M-th image frame by comparing the first feature point with the second feature point. Specifically, the more similar the direction of the upper body determined based on the first feature point and the direction of the upper body determined based on the second feature point are to each other, the easier it may be to replace the face of the i-th person in the j-th image frame with the face of the i-th person in the M-th image frame and the higher the compatibility score may be calculated.

The electronic device may determine the position, direction, angle and perspective of the face of the i-th person, as well as whether the connection between the face and the neck of the i-th person is natural and whether the direction of the face and the direction of the body are natural, by comparing at least one first feature point corresponding to the i-th person in the j-th image frame with at least one second feature point corresponding to the i-th person in the M-th image frame. The electronic device may calculate a compatibility score for the i-th person between the j-th image frame and the M-th image frame based on a comparison result between the first feature point and the second feature point.

### 3. Regarding the Determination of the Base Image:

In an embodiment of the disclosure, the electronic device may determine the base image based on the aesthetic score and the compatibility score. In operation S310, the electronic device may determine the base image based on the aesthetic score and the compatibility score. For example, the base image may be determined by Equation 3 based on the aesthetic score and the compatibility score.

$${arg max}_{j} {\sum }_{i} max ( {S}_{j , 1}^{i} \cdot {A}_{1}^{i} {S}_{j , 2}^{i} \cdot {A}_{2}^{i} , ⋯ , {S}_{j , M}^{i} \cdot {A}_{M}^{i} ) \qquad Equation 3$$

S_{j,M}ⁱ in Equation 3 is the same as that in Equation 2, and redundant descriptions are omitted.

Aⱼⁱ in Equation 3 is the same as that in Equation 1, and redundant descriptions are omitted.

In Equation 3, S_{j,M}ⁱ·A_{M}ⁱ may refer to an equation that comprehensively considers the swap compatibility and completion level of shooting for the i-th person between the j-th image frame and the M-th image frame.

Equation 3 may refer to an equation for determining the M-th image frame having a comprehensively high swap compatibility and shooting completion level for the i-th person in the j-th image frame, obtaining a value by adding all S_{j.M}ⁱ·A_{M}ⁱ values for each person in the j-th image frame, and deriving the j-th image frame having the highest obtained value. Equation 3 may be an equation designed to select the best image among a plurality of images by considering the swap compatibility between a plurality of persons included in the j-th image frame and each person included in another image frame, and the completion level of shooting of the plurality of persons included in the j-th image frame. However, this is only an example, and the technical idea of the disclosure for determining the base image is not limited to Equation 3.

With regard to the determination of the source image, in an embodiment of the disclosure, the electronic device may determine the source image based on the aesthetic score and the compatibility score. The electronic device may determine the source image among a plurality of images based on the aesthetic score and the compatibility score regarding a target person included in the plurality of images. In operation S320, the electronic device may determine the source image based on the aesthetic score and the compatibility score. For example, the source image may be determined by Equation 4 based on the aesthetic score and the compatibility score.

$$max ( {S}_{j , 1}^{i} \cdot {A}_{1}^{i} , {S}_{j , 2}^{i} \cdot {A}_{2}^{i} , ⋯ , {S}_{j , M}^{i} \cdot {A}_{M}^{i} ) \qquad Equation 4$$

S_{j,M}ⁱ in Equation 4 is the same as that in Equation 2, and redundant descriptions are omitted.

Aⱼⁱ in Equation 4 is the same as that in Equation 1, and redundant descriptions are omitted.

In Equation 4, S_{j,M}^{·A}_{M}ⁱ may refer to an equation that comprehensively considers the swap compatibility and completion level of shooting for the i-th person between the j-th image frame and the M-th image frame.

Equation 4 may refer to an equation for determining the M-th image frame having the highest swap compatibility and shooting completion level for the i-th person in the j-th image frame. Equation 4 may be an equation designed to select the best image in which the target person is best shot from among a plurality of images by considering the swap compatibility between the target person included in the j-th image frame and the target person included in another image frame, and the completion level of shooting of the target person included in the j-th image frame. However, this is only an example, and the technical idea of the disclosure for determining the source image is not limited to Equation 4.

In an embodiment of the disclosure, the source image may be determined from external images stored separately. In the disclosure, the source image is described as being determined from among a plurality of images obtained by the electronic device, but the source image may also be determined from received external images. The electronic device may receive external images of a first person from a separate server or database and may determine, from among the external images, a source image for replacing a face region of the first person in a base image.

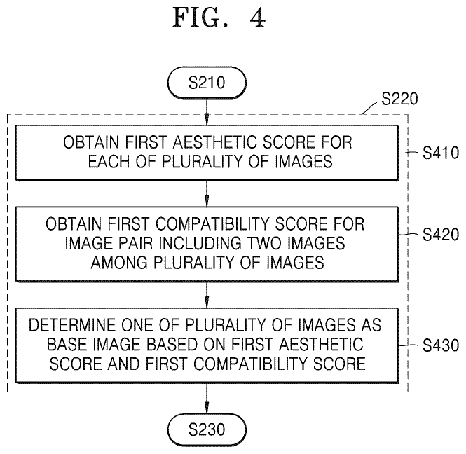

FIG. 4 is a flowchart illustrating a method of determining a base image among a plurality of images, according to an embodiment of the disclosure.

For convenience of description, descriptions that are the same as those given with reference to FIG. 2 are simplified or omitted.

Referring to FIG. 4, operation S220 of FIG. 2 may include operations S410, S420, and S430 of FIG. 4.

In operation S410, the electronic device may obtain a first aesthetic score for each of the plurality of images.

In an embodiment of the disclosure, the first aesthetic score may be a score obtained by numerically qualifying the completion level of shooting of face regions of a plurality of persons with respect to each of the plurality of images. The first aesthetic score may refer to an aesthetic score determined for any person among the plurality of persons included in the plurality of images.

For example, the electronic device may obtain a first aesthetic score determined for a first person among the plurality of persons included in the plurality of images, with respect to each of the plurality of images. The electronic device may obtain a first aesthetic score determined for a second person among the plurality of persons included in the plurality of images, with respect to each of the plurality of images. The first aesthetic score may include aesthetic scores respectively determined for the plurality of persons included in each of the plurality of images, with respect to each of the plurality of images.

In an embodiment of the disclosure, the electronic device may detect a face region of a person included in the plurality of images. The electronic device may obtain a first aesthetic score of the person based on the detected face region. A method of detecting the face region may generally be performed through object detection, and the technical idea of the disclosure is not limited thereto.

In an embodiment of the disclosure, the first aesthetic score may be determined based on whether the face of a person included in an image is well shot. For example, the first aesthetic score may be determined based on preferences extracted from external images of a target person stored in database.

In operation S420, the electronic device may obtain a first compatibility score for an image pair including two images among the plurality of images.

In an embodiment of the disclosure, the first compatibility score may be a score obtained by numerically quantifying the swap compatibility between a face region pair of one person of the plurality of persons included in an image pair, the image pair including two images among the plurality of images. The first compatibility score may refer to a compatibility score determined for any person among the plurality of persons included in the plurality of images.

For example, the electronic device may obtain a first compatibility score determined for the first person among the plurality of persons included in one target image and one comparison image among the plurality of images. The electronic device may obtain a first compatibility score determined for a second person among the plurality of persons included in one target image and one comparison image among the plurality of images. The first compatibility score may include compatibility scores determined for each of the plurality of persons between one target image and one comparison image among the plurality of images. The plurality of persons may be persons included in both one target image and one comparison image.

In an embodiment of the disclosure, the electronic device may detect a face region of a person included in the plurality of images. The electronic device may obtain a first compatibility score of the person based on the detected face region. A method of detecting the face region may generally be performed through object detection, and the technical idea of the disclosure is not limited thereto.

In an embodiment of the disclosure, the electronic device may detect a body region connected to the face of the person included in the plurality of images. The electronic device may obtain a first compatibility score of the person based on the detected face region and body region. For example, the electronic device may determine the compatibility score based on not only the face but also the degree of similarity of the pose of the body connected to the face.

In operation S430, the electronic device may determine one of the plurality of images as a base image based on the first aesthetic score and the first compatibility score.

In an embodiment of the disclosure, the electronic device may evaluate the plurality of images through the first aesthetic score and the first compatibility score. For example, an equation for evaluating the plurality of images may include Equation 3 described with reference to FIG. 3. The electronic device may evaluate the plurality of images according to Equation 3 and may determine, as the base image, an image having the highest evaluation from among the plurality of images. However, Equation 3 for evaluating the plurality of images is only an example, and the technical idea of the disclosure is not limited to Equation 3.

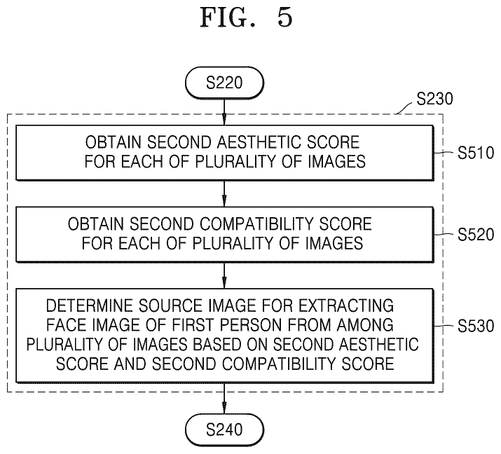

FIG. 5 is a flowchart illustrating a method of determining a target image among a plurality of images, according to an embodiment of the disclosure.

For convenience of description, descriptions that are the same as those given with reference to FIGS. 2 and 4 are simplified or omitted.

In an embodiment of the disclosure, operation S230 of FIG. 2 may include operations S510, S520, and S530 of FIG. 5.

In operation S510, the electronic device may obtain a second aesthetic score for each of the plurality of images.

In an embodiment of the disclosure, the second aesthetic score may be a score obtained by numerically qualifying the completion level of shooting of face regions of a plurality of persons with respect to each of the plurality of images. The second aesthetic score may refer to an aesthetic score determined for the first person among the plurality of persons included in the plurality of images.

For example, the electronic device may obtain a second aesthetic score for the first person in order to replace the face region of the first person. Therefore, the second aesthetic score for each of the plurality of images is determined for the first person included in the plurality of images. Among the plurality of images, the image having the highest second aesthetic score may imply that the image is an image in which the face region of the first person is best shot.

In operation S520, the electronic device may obtain a second compatibility score for each of the plurality of images.

In an embodiment of the disclosure, the second compatibility score may be a score obtained by numerically quantifying the swap compatibility between a face region pair of the first person included in an image pair, the image pair including two images among the plurality of images. The second compatibility score may refer to a compatibility score determined for the first person included in the plurality of images.

For example, the electronic device may obtain a second compatibility score determined for the first person among the plurality of persons included in one target image and one comparison image among the plurality of images. Therefore, the second compatibility score between one target image and one comparison image is determined for the first person included in the two images. The fact that the second aesthetic score between one target image and one comparison image is the highest may include the meaning that the face region of the first person in one target image is suitable for being replaced with the face region of the first person in one comparison image.

In operation S530, the electronic device may identify a source image for extracting the face region of the first person from among the plurality of images based on the second aesthetic score and the second compatibility score.

In an embodiment of the disclosure, the electronic device may evaluate a relationship between two images from among the plurality of images for replacing the face region of the first person based on the second aesthetic score and the second compatibility score. For example, an equation for evaluating the relationship between two images from among the plurality of images may include Equation 4 described with reference to FIG. 3. The electronic device may evaluate a relationship between one target image and one comparison image according to Equation 4 and may determine, as the source image, a comparison image having the highest evaluation from among the plurality of images based on the one target image. However, Equation 4 is only an example, and the technical idea of the disclosure is not limited to Equation 4.

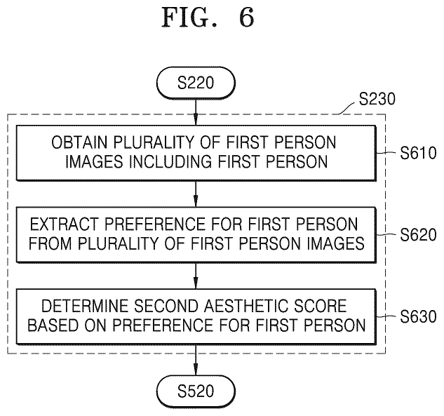

FIG. 6 is a flowchart illustrating a method of considering a user's preference to determine a target image, according to an embodiment of the disclosure.

For convenience of description, descriptions that are the same as those given with reference to FIGS. 2 and 5 are simplified or omitted.

In an embodiment of the disclosure, operation S510 of FIG. 5 may include operations S610, S620, and S630 of FIG. 6.

In operation S610, the electronic device may obtain a plurality of first person images including a first person.

In an embodiment of the disclosure, the electronic device may obtain the plurality of first person images through a communication unit. For example, the electronic device may obtain the plurality of first person images through a server.

In an embodiment of the disclosure, the electronic device may obtain the first person images from a memory. The memory may include a cluster that stores data having the same attributes, and the electronic device may obtain a plurality of first person images from the cluster for the first person.

In operation S620, the electronic device may extract a preference for the first person from the plurality of first person images.

In an embodiment of the disclosure, the electronic device may extract a preference for the first person from a pose of the first person included in the plurality of first person images. The preference for the first person may be determined based on at least one of facial expression, clothing, hairstyle, eye blink, head pose, hand pose, or occluding of the first person included in the first person image.

For example, the preference for the first person may be determined based on the frequency of the shape of the first person in the plurality of first person images, the first person being included in the plurality of first person images. The shape of the first person may refer to expression, clothing, hairstyle, eye blink, head pose, hand pose, occluding, or the like of the first person. As a specific example, when the frequency of the smiling expression of the first person in the plurality of first person images is high, it may be determined that the preference for the smiling expression is high.

In operation S630, the electronic device may determine the second aesthetic score based on the preference for the first person.

In an embodiment of the disclosure, the electronic device may determine the second aesthetic score for the first person to be higher for an image that includes a high preference element for the first person from among the plurality of images. The electronic device may determine the second aesthetic score for the first person to be lower for an image that includes a low preference element for the first person from among the plurality of images.

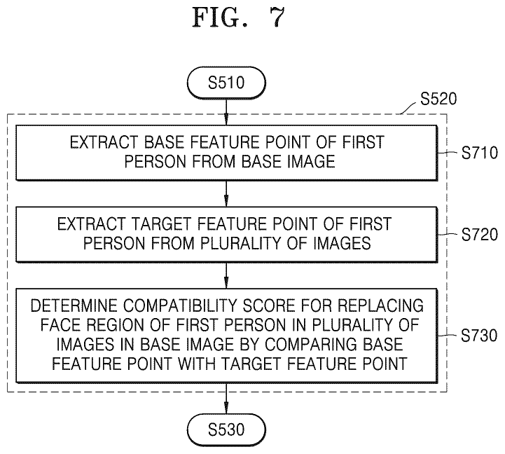

FIG. 7 is a flowchart illustrating a method of considering a user's pose to determine a target image, according to an embodiment of the disclosure.

For convenience of description, descriptions that are the same as those given with reference to FIGS. 2 and 5 are simplified or omitted.

In an embodiment of the disclosure, operation S520 of FIG. 5 may include operations S710, S720, and S730 of FIG. 7.

In operation S710, the electronic device may extract a base feature point of the first person from a base image. In operations S720, the electronic device may extract a target feature point of the first person from a plurality of images.

In an embodiment of the disclosure, a processor of the electronic device may include an artificial intelligence algorithm or an artificial intelligence network for obtaining a feature point from the base image. The artificial intelligence algorithm or the artificial intelligence network may be an artificial intelligence model including a feature point extraction algorithm.

In an embodiment of the disclosure, the electronic device may extract the base feature point of the first person from the base image by using the artificial intelligence model. In an embodiment of the disclosure, the electronic device may extract the target feature point of the first person from the plurality of images by using the artificial intelligence model.

In operation S730, the electronic device may determine a compatibility score for replacing the face region of the first person in the plurality of images in the base image by comparing the base feature point with the target feature point.

In an embodiment of the disclosure, the base feature point and the target feature point may each include a position value of a point corresponding to a major position of the body of the first person. The electronic device may compare the poses of the first person included in the base image and one of the plurality of images by comparing, to each other, the base feature point and the target feature point corresponding to the same position. The electronic device may determine a compatibility score based on the comparison result.

For example, the electronic device may determine a similarity degree of the face pose of the first person included in the base image and one of the plurality of images by comparing, to each other, the base feature point and the target feature point each corresponding to the major position of the face of the first person. The electronic device may determine a compatibility score for replacing the face region of the first person in one of the plurality of images in the base image by considering the similarity degree of the face pose of the first person included in the base image and one of the plurality of images.

In another example, the electronic device may determine the similarity degree of the body pose of the first person included in each of the base image and one of the plurality of images by comparing the base feature point and the target feature point each corresponding to the major position of the body of the first person. The electronic device may determine a compatibility score for replacing the face region of the first person in one of the plurality of images in the base image by considering the similarity degree of the body pose of the first person included in each of the base image and one of the plurality of images.

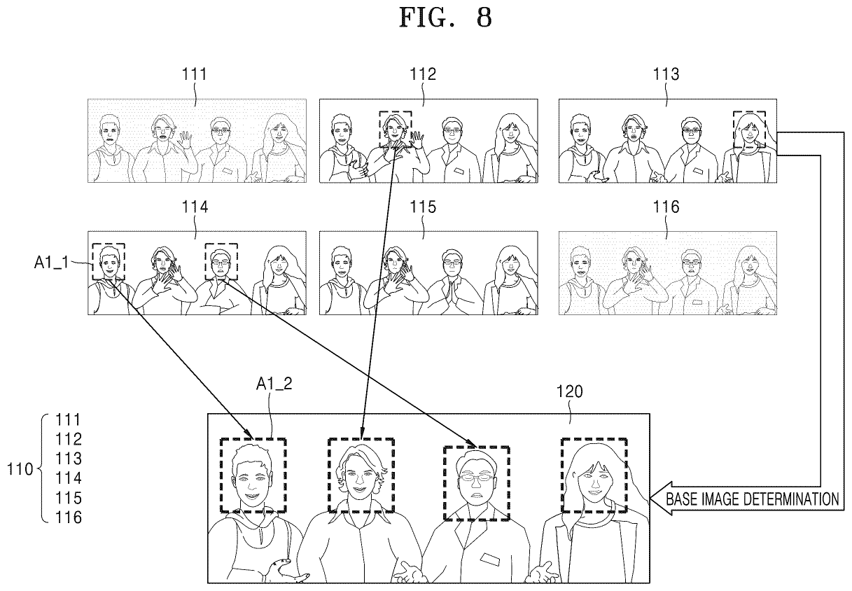

FIG. 8 is a conceptual diagram illustrating a method of filtering a plurality of images to remove a blurry image and then generating a corrected image based on the filtered plurality of images, according to an embodiment of the disclosure.

For convenience of description, descriptions that are the same as those given with reference to FIG. 1 are simplified or omitted.

Referring to FIG. 8, in an embodiment of the disclosure, the electronic device may obtain a plurality of images 110 including first to sixth images 111, 112, 113, 114, 115, and 116. The plurality of images 110 may be images continuously captured over a set period of time.

In an embodiment of the disclosure, the plurality of images 110 may have different blurriness. The blurriness may refer to the degree of blurring in which details of an image are smoothly blurred or dimmed.

For example, the blurriness may be determined by various reasons, such as incorrect focus setting of a camera lens, movement of a subject during shooting, shutter speed when shooting (for example, a slow shutter speed may cause an image to be blurred due to movement or hand shake), lens quality, and information loss that occurs when compressing and storing an image. However, the technical idea of the disclosure does not limit the factors affecting blurriness.

In an embodiment of the disclosure, the electronic device may set a threshold. The electronic device may determine an image, the blurriness of which exceeds the threshold, from among the plurality of images 110 as a blurred image. The electronic device may determine an image, the blurriness of which does not exceed the threshold, from among the plurality of images 110 as a clear image.

For example, as illustrated in FIG. 8, the electronic device may determine the blurriness of each of the plurality of images 110. The electronic device may determine that the blurriness of the first image 111 and the sixth image 116 exceed the threshold value. The electronic device may determine the first image 111 and the sixth image 116 as blurred images. The electronic device may determine that the blurriness of the second image 112 to the fifth image 115 does not exceed the threshold value. The electronic device may determine the second image 112 to the fifth image 115 as clear images.

In an embodiment of the disclosure, the electronic device may select a clear image by filtering the plurality of images 110. The electronic device may select the second image 112 to the fifth image 115, which are clear images among the plurality of images 110. The electronic device may perform the method of generating a correction image, the method being described with reference to FIG. 1, based on the clear images. This will be briefly described.

In an embodiment of the disclosure, the electronic device may obtain the second image 112 to the fifth image 115 as clear images by filtering the plurality of images 110.

The electronic device may determine any one of the second image 112 to the fifth image 115 as a base image. For example, the electronic device may determine the second image 112 as the base image.

In an embodiment of the disclosure, the electronic device may determine any one image among the clear images as a source image in order to replace a face region A1_2 of the first person in the base image. The electronic device may determine, as the source image for the first person, the fourth image 114 from among the second to fifth images 112, 113, 114, and 115 including the first person. The source image for the first person may refer to a source image selected to replace the face region A1_2 of the first person in the base image.

In an embodiment of the disclosure, the electronic device may extract a face region A1_1 of the first person included in the source image for the first person. For example, the electronic device may extract the face region A1_1 of the first person from the fourth image 114.

In an embodiment of the disclosure, the electronic device may replace the face region A1_2 of the first person in the base image with the face region A1_1 of the first person in the source image.

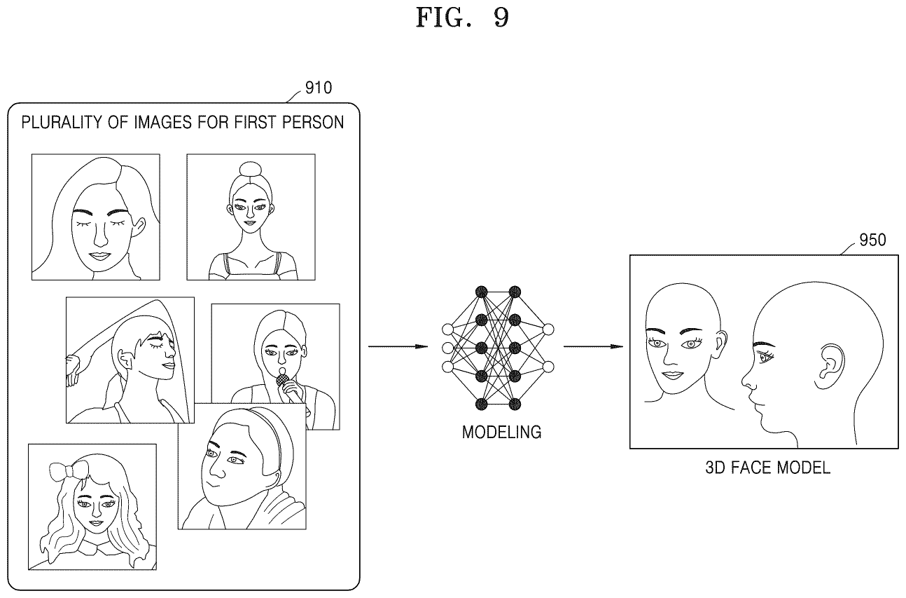

FIG. 9 is a conceptual diagram illustrating an operation of generating a three-dimensional (3D) face model based on an image including the first person, according to an embodiment of the disclosure.

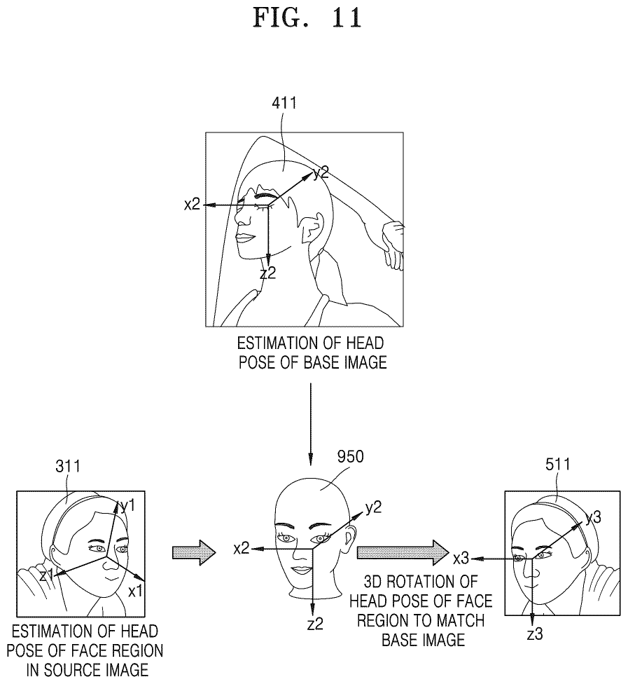

In an embodiment of the disclosure, the electronic device may generate a 3D face model 950 based on a plurality of images 910. The electronic device may correct an image based on the 3D face model 950, and a specific embodiment of correcting the image based on the 3D face model 950 will be described below with reference to FIGS. 11 to 13.

In an embodiment of the disclosure, the electronic device may obtain the plurality of images 910 of the first person. The plurality of images 910 may be images including a face region of the first person and may be images captured from various sides of the face region of the first person.

The plurality of images 910 may be images continuously captured over a set period of time. The plurality of images 910 may include an image sequence, which refers to a series of image sets arranged in order over time. For example, the plurality of images 910 may refer to images including the first person from among the plurality of images 110 described with reference to FIG. 1. The plurality of images 910 may be images that are stored separately. The electronic device may obtain the plurality of images 910 for the first person from a cluster for the first person. The cluster for the first person may be a configuration that collects and stores images for the first person. The electronic device may also obtain the plurality of images 910 through a separate server.

In an embodiment of the disclosure, the electronic device may generate the 3D face model 950 by 3D modeling the plurality of images 910. A processor of the electronic device may include an artificial intelligence algorithm or an artificial intelligence network for obtaining the 3D face model 950 of a target person from a plurality of two-dimensional (2D) images including the target person. The artificial intelligence algorithm or the artificial intelligence network may be an artificial intelligence model including an algorithm for generating the 3D face model 950.

In an embodiment of the disclosure, the plurality of images 910 may correspond to the plurality of images 110 of FIG. 1. For example, the electronic device may obtain the plurality of images 110 that are continuously captured as described with reference to FIG. 1. The captured plurality of images 110 may be images including the target person. The electronic device may obtain the plurality of images 110 captured, for example, through a motion photo function. The electronic device may obtain the plurality of images 110 that are stored in a video format. The electronic device may generate the 3D face model 950 regarding the face of the target person based on the obtained plurality of images 110. For example, the electronic device may generate the 3D face model 950 regarding the face of the first person based on the obtained plurality of images 110 including the first person.

In an embodiment of the disclosure, the 3D face model 950 may include an image or simulation data that represents the head of the target person in three dimensions. The 3D face model 950 may represent the curvature, parts, texture, etc. of the face of the target person. The 3D face model 950 mainly expresses the face of the target person, but is not limited to the face. For example, the 3D face model 950 may include an image or simulation data that further includes a part of the neck and upper body connected to the face.

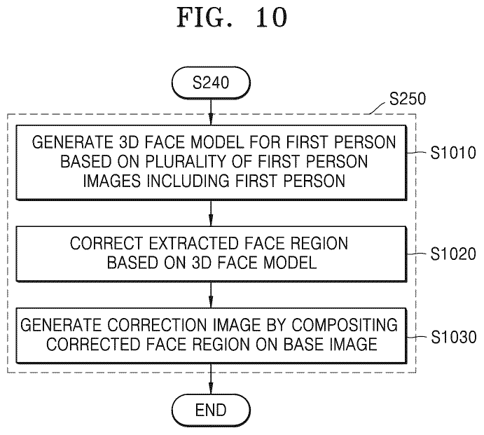

FIG. 10 is a flowchart illustrating a method of correcting a face region of a base image based on a 3D face model, according to an embodiment of the disclosure.

For convenience of description, descriptions that are the same as those given with reference to FIGS. 2 and 9 are simplified or omitted.

Referring to FIG. 10, operation S250 of FIG. 2 may include operations S1010, S1020, and S1030 of FIG. 10.

In operation S1010, the electronic device may generate a 3D face model for the first person based on a plurality of first person images including the first person.

In an embodiment of the disclosure, the electronic device may obtain the first person images. The first person images may be stored in a cluster for the first person or may be stored through a separate server. The electronic device may obtain the first person images from the cluster or the separate server by using a communication unit.

In an embodiment of the disclosure, the electronic device may generate the 3D face model based on the plurality of first person images. The electronic device may generate the 3D face model by 3D modeling the plurality of first images. The processor of the electronic device may include an artificial intelligence algorithm or an artificial intelligence network for obtaining the 3D face model of the first person from the plurality of first person images including the first person. The artificial intelligence algorithm or the artificial intelligence network may be an artificial intelligence model including an algorithm for generating the 3D face model.

In operation S1020, the electronic device may correct an extracted face region based on the 3D face model.

In an embodiment of the disclosure, the electronic device may extract the face region of the first person in a source image. The extracted face region may be an image corresponding to the face region of the first person in the source image for replacing the face of the first person. The electronic device may correct the face region based on the 3D face model.

For example, when a face direction of the face region extracted from the source image does not match a face direction of the first person in the base image, the electronic device may correct the face direction of the extracted face region to match the face direction of the first person in the base image. The electronic device may correct the face region by changing the face direction of the extracted face region based on a 3D shape and displaying the face region having the changed face direction again on a 2D image. An embodiment of the disclosure related to this will be described in detail below with reference to FIG. 11.

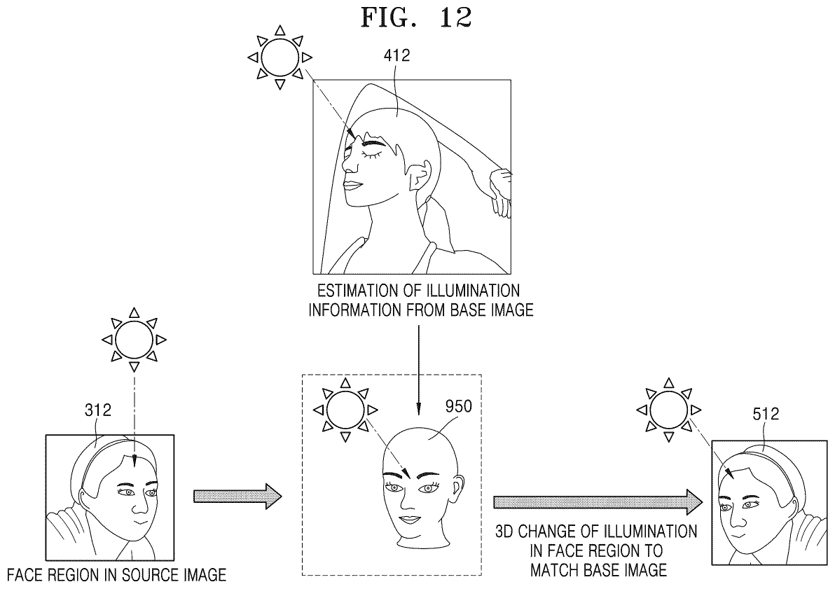

In another example, when the illumination for the extracted face region does not match the illumination for the first person in the base image, the electronic device may correct the illumination for the extracted face region to match the illumination for the first person in the base image. The electronic device may correct the face region by changing the illumination for the extracted face region based on the 3D shape and displaying the face region having the changed illumination again on the 2D image. An embodiment of the disclosure related to this will be described in detail below with reference to FIG. 12.

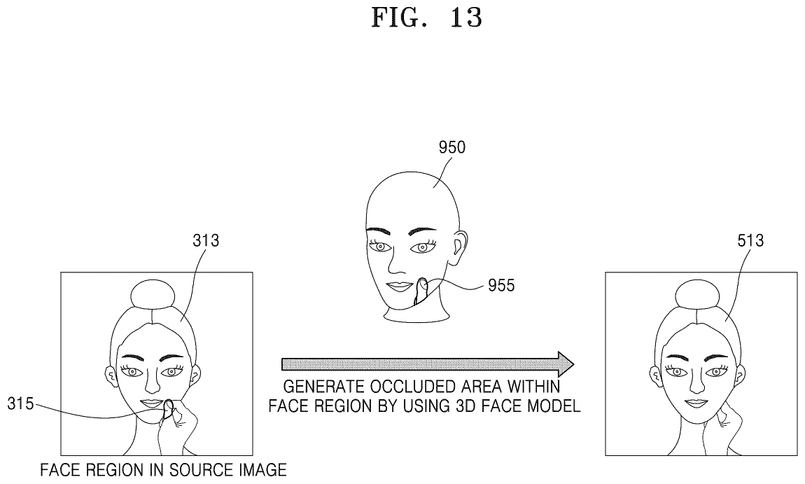

In another example, when there is a region that occludes the face in the extracted face region, the electronic device may extract a face fragment corresponding to the occluded face region from the 3D face model. The electronic device may combine the face fragment extracted from the 3D face model with the face region extracted from the source image, based on the 3D face model. The electronic device may correct the face region by displaying the combined face region again on the 2D image. An embodiment of the disclosure related to this will be described in detail below with reference to FIG. 13.

In operation S1030, the electronic device may generate a correction image by compositing the corrected face region on the base image.

In an embodiment of the disclosure, the electronic device may correct the base image by replacing the face region of the first person in the base image with the face region of the first person in the source image. The description of operation S1030 is not different from the description of operation S250, and thus is omitted.

FIG. 11 is a conceptual diagram illustrating a method of rotating a pose of a face region based on a 3D face model, according to an embodiment of the disclosure.

For convenience of description, descriptions that are the same as those given with reference to FIGS. 1 to 10 are simplified or omitted.

Referring to FIG. 11, in an embodiment of the disclosure, the electronic device may determine, from among a plurality of images, a source image 311 for replacing a face region of the first person and a base image 411. The electronic device may obtain head pose information of the first person included in the source image 311. The head pose information may include information on at least one of a direction or an angle of the face of the first person.

For example, the direction and angle of the face of the first person may be determined using an x-y-z coordinate system. The electronic device may obtain head pose information of the first person included in the source image 311, and the direction and angle of the face of the first person may be determined using three axes of x1, y1, and z1.

In an embodiment of the disclosure, the electronic device may obtain head pose information of the first person included in the base image 411. For example, the direction and angle of the face of the first person included in the base image 411 may be determined using three axes of x2, y2, and z2.

In an embodiment of the disclosure, the electronic device may obtain a 3D face model 950. The electronic device may determine the head pose of the 3D face model 950 based on the head pose information of the first person included in the base image 411. As illustrated in FIG. 11, the electronic device may rotate the face direction and angle of the 3D face model 950 based on the head pose information of the first person included in the base image 411. The electronic device may change the face direction and angle of the 3D face model 950 to match the head pose information of the first person included in the base image 411. The face direction and angle of the 3D face model 950 may be changed to be determined using three axes of x2, y2, and z2.

In an embodiment of the disclosure, the electronic device may rotate the face region of the first person included in the source image 311 based on the changed face direction and angle of the 3D face model 950. The electronic device may change the face region of the first person included in the source image 311 to match the changed face direction and angle of the 3D face model 950.

For example, the electronic device may overlap the face region of the first person included in the source image 311 onto the 3D face model 950 having the changed face direction and angle. The electronic device may change the face region of the first person included in the source image 311 by converting the 3D face model 950, which the face region of the first person overlaps, into a 2D image. The face region of the first person included in the source image 311 may be changed from the face direction and angle determined by the three axes of x1, y1, and z1 to the face direction and angle determined by the three axes of x2, y2, and z2.

The electronic device may obtain a source image 511 in which the face direction and angle of the first person are changed.

FIG. 12 is a conceptual diagram illustrating a method of changing the illumination of a face region based on a 3D face model, according to an embodiment of the disclosure.

For convenience of description, descriptions that are the same as those given with reference to FIGS. 1 to 11 are simplified or omitted.

Referring to FIG. 12, in an embodiment of the disclosure, the electronic device may determine, from among a plurality of images, a source image 312 for replacing a face region of the first person and a base image 412. The electronic device may obtain illumination information for the first person included in the source image 312. The electronic device may obtain illumination information for the first person included in the base image 412.

The illumination information for the first person may include information on brightness considering the curvature of the face as light shines toward the face of the first person.

In an embodiment of the disclosure, the electronic device may obtain a 3D face model 950. The electronic device may determine brightness considering the curvature of the face on the 3D face model 950 based on the illumination information for the first person included in the base image 412. As illustrated in FIG. 12, the electronic device may change the brightness of the 3D face model 950 based on the illumination information for the first person included in the base image 412. The electronic device may change the brightness of the 3D face model 950 to match the illumination information for the first person included in the base image 412.

In an embodiment of the disclosure, the electronic device may change the brightness of the face of the first person included in the source image 312 based on the changed brightness of the 3D face model 950. The electronic device may change the face region of the first person included in the source image 312 to match the changed brightness of the 3D face model 950.

For example, the electronic device may overlap the face region of the first person included in the source image 312 onto the 3D face model 950 having changed brightness of the face. The electronic device may change the face region of the first person included in the source image 312 by converting the 3D face model 950, which the face region of the first person overlaps, into a 2D image.

The electronic device may obtain a source image 511 whose brightness is changed toward the first person.

FIG. 13 is a conceptual diagram illustrating a method of correcting an occluded area in a face region based on a 3D face model, according to an embodiment of the disclosure.

For convenience of description, descriptions that are the same as those given with reference to FIGS. 1 to 12 are simplified or omitted.

Referring to FIG. 13, in an embodiment of the disclosure, the electronic device may determine, from among a plurality of images, a source image 313 for replacing a face region of the first person and a base image. The electronic device may determine whether an occlusion area 315 is formed on the face of the first person included in the source image 313.

In an embodiment of the disclosure, when the occlusion area 315 is not formed on the face of the first person included in the source image 313, the electronic device may generate a corrected image by replacing the face region in the base image with the face region in the source image according to the embodiments of the disclosure described with reference to FIGS. 1 to 12.

In an embodiment of the disclosure, when the occlusion area 315 is formed on the face of the first person included in the source image 313, the electronic device may obtain a first face image excluding the occlusion area 315 from the source image 313. The first face image may be an image from which the occlusion area 315 is excluded from the source image 313.

In an embodiment of the disclosure, the electronic device may obtain a 3D face model 950. The electronic device may obtain the 3D face model 950 based on face images of the first person. In an embodiment of the disclosure, the electronic device may obtain an image corresponding to the occlusion area 315 on the face of the first person included in the source image 313, based on the three-dimensional shape of the 3D face model 950. The electronic device may obtain a second face image 955 corresponding to the occlusion area 315 on the face of the first person included in the source image 313.

In an embodiment of the disclosure, the electronic device may remove the occlusion region 315 on the face of the first person by combining the first face image with the second face image 955. The electronic device may obtain a third face image 513 from which the occlusion region 315 is removed. The third face image 513 may be an image obtained by combining the first face image with the second face image 955 and may be a face image of the first person from which the occlusion region 315 is removed.

For example, the electronic device may adjust the 3D face model 950 to match the face direction of the first person included in the source image 313. The electronic device may combine the first face image with the second face image 955 by overlapping the first face image on the 3D face model 950. The electronic device may obtain the third face image 513 from which the occlusion area 315 is removed by converting the 3D face model 950 overlapping the first face image into a 2D image.

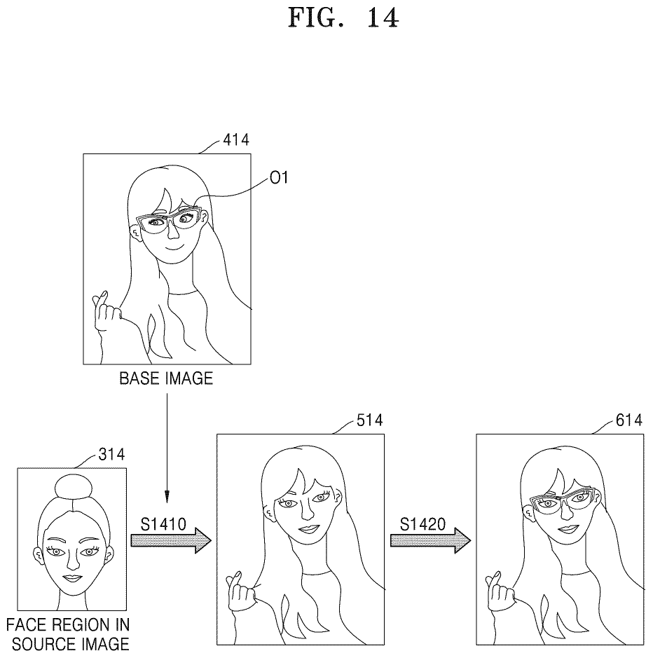

FIG. 14 is a conceptual diagram illustrating a method of reflecting an object on a finally corrected image when an object is present in a face region of a base image, according to an embodiment of the disclosure.

For convenience of description, descriptions that are the same as those given with reference to FIGS. 1 to 13 are simplified or omitted.

Referring to FIG. 14, in an embodiment of the disclosure, the electronic device may determine, from among a plurality of images, a source image 314 for replacing a face region of the first person and a base image 414. The electronic device may detect an object O1 located within the face region of the first person in the base image 414. The detected object O1 may be an object worn by the first person in the base image 414.

The detected object O1 may refer to an object photographed together with the first person in the base image 414. For example, the object O1 may refer to accessories worn by the first person, and may specifically include glasses, a hat, earrings, a mask, etc.

In an embodiment of the disclosure, the object O1 may be located within the face of the first person. In an embodiment of the disclosure, the electronic device may detect the object O1 located within the face of the first person in the base image 414 and insert the detected object O1 into the same or corresponding position in a second correction image 614. A region occupied by the detected object O1 in the base image 414 may replace a corresponding region in the second correction image 614.

In an embodiment of the disclosure, the processor of the electronic device may include an artificial intelligence algorithm or an artificial intelligence network for detecting or classifying an object from an image. The artificial intelligence algorithm or the artificial intelligence network may be an artificial intelligence model including a feature extraction algorithm. The electronic device may detect or classify an object within a face region by using the artificial intelligence model.

For example, the electronic device may determine the base image 414 from among a plurality of images. The electronic device may detect the object O1 located within the face of the first person in the base image 414.

In an embodiment of the disclosure, the electronic device may obtain a face region of the first person from the source image 314. In operation S1410, the electronic device may composite the face region of the first person in the source image 314 on the face region of the first person in the base image 414. The electronic device may replace the face region of the first person in the base image 414 with the face region of the first person in the source image 314.

As a result, the electronic device may obtain a first correction image 514. The first correction image 514 may be an image in which the face region of the first person in the base image 414 is replaced with the face region of the first person in the source image 314 based on the base image 414.

In an embodiment of the disclosure, in operation S1420, the electronic device may extract an image of the object O1 located within the face of the first person from the base image 414. The electronic device may composite the extracted image of the object O1 on the first correction image 514. As a result, the electronic device may obtain a second correction image 614. The second correction image 614 may be an image in which the image of the object O1 extracted from the base image 414 is added based on the first correction image 514. Therefore, the second correction image 614 may be an image in which the face region of the first person in the base image 414 is replaced with the face region of the first person in the source image 314 based on the base image 414 and the image of the object O1 worn by the first person in the base image 414 is composited.

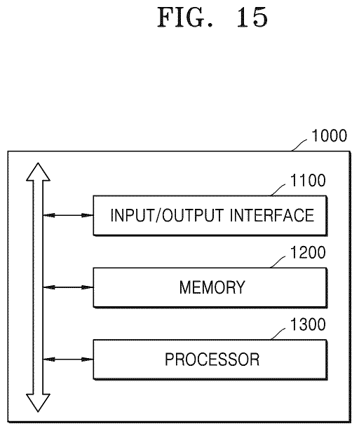

Hereinafter, with reference to FIG. 15, the configuration of an electronic device for performing the image processing operations described so far will be described. FIG. 15 is a block diagram illustrating the configuration of an electronic device according to an embodiment of the disclosure.

For convenience of description, descriptions that are the same as those given with reference to FIGS. 1 to 14 are simplified or omitted.

Referring to FIG. 15, an electronic device 1000 according to an embodiment of the disclosure may include an input/output interface 1100, a memory 1200, and a processor 1300. However, the components of the electronic device 1000 are not limited to the above-described examples, and the electronic device 1000 may include more or fewer components than the above-described components. In an embodiment of the disclosure, some or all of the input/output interface 1100, the memory 1200, and the processor 1300 may be implemented in the form of a single chip, and the processor 1300 may include one or more processors.

The input/output interface 1100 may include an input interface (e.g., a touch screen, a hard button, or a microphone) for receiving control commands or information from a user, and an output interface (e.g., a display panel or a speaker) for displaying the execution result of an operation according to the user's control or the status of the electronic device 1000.

For example, the electronic device 1000 may obtain a plurality of images based on the user's image capture command obtained through the input/output interface 1100. The processor 1300 of the electronic device 1000 may determine a base image and a source image based on the plurality of images and perform the image processing operations described with reference to FIGS. 1 to 14.

The memory 1200 is a configuration for storing various programs or data, and may be configured as a storage medium, such as read only memory (ROM), random access memory (RAM), hard disk, compact disc (CD)-ROM, and digital video disc (DVD), or a combination of storage media. The memory 1200 may not exist separately and may be configured to be included in the processor 1300. The memory 1200 may be configured as a volatile memory, a nonvolatile memory, or a combination of a volatile memory and a nonvolatile memory. The memory 1200 may store programs or instructions for performing operations according to the embodiments of the disclosure described above with reference to FIGS. 1 to 14. The memory 1200 may also provide stored data to the processor 1300 according to a request from the processor 1300.

The processor 1300 is a configuration for controlling a series of processes so that the electronic device 1000 operates according to the embodiments of the disclosure described above with reference to FIGS. 1 to 14, and may be configured as one or more processors. One or more processors included in the processor 1300 may be circuitry, such as a system on chip (SoC) or an integrated circuit (IC). In this case, the one or more processors may be general-purpose processors, such as central processing unit (CPU), application processor (AP), and digital signal processor (DSP), dedicated graphics processors, such as graphics processing unit (GPU) and vision processing unit (VPU), or dedicated AI processors, such as neural network processing unit (NPU). For example, when the one or more processors are dedicated AI processors, the dedicated AI processors may be designed with a hardware structure specialized for processing a specific AI model.

The processor 1300 may record data in the memory 1200 or read data stored in the memory 1200, and in particular, may process data according to predefined operation rules or an AI model by executing a program or at least one instruction stored in the memory 1200. Accordingly, the processor 1300 may perform the operations described in the embodiments of the disclosure described above, and the operations described as performed by the electronic device 1000 in the embodiments of the disclosure described above may be considered to be performed by the processor 1300 unless otherwise specifically described.

A method according to an embodiment of the disclosure may include: obtaining a plurality of images each comprising a plurality of persons, identifying one image among the plurality of images as a base image, identifying a source image among the plurality of images based on a completion level of each of the plurality of images and a swap compatibility of each of the plurality of images, extracting a face region of a person of the plurality of persons from the source image, and generating a correction image by compositing the extracted face region on the base image, wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

In an embodiment of the disclosure, the plurality of images comprise images continuously captured over a set period of time.

In an embodiment of the disclosure, the identifying one image among the plurality of images as the base image comprises: obtaining, with respect to each of the plurality of images, a first aesthetic score by numerically quantifying the completion level of shooting of a face region of each of the plurality of persons, obtaining, with respect to an image pair comprising two images of the plurality of images, a first compatibility score by numerically quantifying a swap compatibility between a face region of the image of the person in each image of the image pair, and identifying one image among the plurality of images as the base image based on the first aesthetic score and the first compatibility score.

In an embodiment of the disclosure, the identifying the source image comprises: obtaining, with respect to each of the plurality of images, a second aesthetic score by numerically quantifying the completion level of shooting of the face regions of a first person, obtaining, with respect to each of the plurality of images, a second compatibility score by numerically quantifying the swap compatibility related to the face region of the first person, and identifying the source image based on the second aesthetic score and the second compatibility score.

In an embodiment of the disclosure, the obtaining, with respect to each of the plurality of images, the second compatibility score comprises: extracting from the base image a base feature point related to a position of a body of the first person, extracting from each of the plurality of images a target feature point related to the position of the body of the first person, and determining the second compatibility score for each of the plurality of images by comparing the base feature point with the target feature point.

In an embodiment of the disclosure, the correction image comprises an image in which the face region of the first person in the base image is replaced with the extracted face region.

In an embodiment of the disclosure, The method further comprises: obtaining a degree of blurriness of each of the plurality of images, and selecting, from among the plurality of images, at least one image of which the degree of blurriness does not exceed a threshold, wherein the identifying one image among the plurality of images as the base image comprises identifying the base image from among the selected at least one image, and wherein the identifying the source image comprises identifying the source image from among the selected at least one image.

In an embodiment of the disclosure, the generating the correction image comprises: generating a three-dimensional (3D) face model of the person based on a plurality of first person images each comprising an image of the person, correcting the extracted face region based on the 3D face model, and generating the correction image by compositing the corrected face region on the base image.

An electronic device to an embodiment of the disclosure comprises: an input/output interface configured to receive a user input requesting processing of an image and to output an image processed according to the user input, at least one memory storing one or more instructions for processing the image, and at least one processor configured to execute the one or more instructions, wherein the one or more instructions, when executed by the at least one processor, cause the electronic device to: obtain a plurality of images each comprising an image of a person, identify one image among the plurality of images as a base image, identify a source image among the plurality of images based on a completion level of each of the plurality of images and a swap compatibility of each of the plurality of images, extract a face region of a person of the plurality of persons from the source image, and generate a correction image by compositing the extracted face region on the base image, wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

In an embodiment of the disclosure, the plurality of images comprise images continuously captured over a set period of time.

In an embodiment of the disclosure, the one or more instructions, when executed by the at least one processor, cause the electronic device to: obtain, with respect to each of the plurality of images, a first aesthetic score by numerically quantifying the completion level of shooting of a face region of each of the plurality of persons, obtain, with respect to an image pair comprising two images of the plurality of images, a first compatibility score by numerically quantifying a swap compatibility between a face region of the image of the person in each image of the image pair, and identify one image among the plurality of images as the base image based on the first aesthetic score and the first compatibility score.

In an embodiment of the disclosure, the one or more instructions, when executed by the at least one processor, cause the electronic device to: obtain, with respect to each of the plurality of images, a second aesthetic score by numerically quantifying the completion level of shooting of the face regions of a first person, obtain, with respect to each of the plurality of images, a second compatibility score by numerically quantifying the swap compatibility related to the face region of the first person, and identify the source image based on the second aesthetic score and the second compatibility score.

In an embodiment of the disclosure, the one or more instructions, when executed by the at least one processor, cause the electronic device to, in obtaining the second compatibility score: extract from the base image a base feature point related to a position of a body of the first person, extract from each of the plurality of images a target feature point related to the position of the body of the first person, and determine the second compatibility score for each of the plurality of images comparing the base feature point with each extracted target feature point.

In an embodiment of the disclosure, the one or more instructions, when executed by the at least one processor, cause the electronic device to: obtain a degree of blurriness of each of the plurality of images, select, from among the plurality of images, at least one image of which the degree of blurriness does not exceed a threshold, identify the base image from among the selected at least one image, and identify the source image from among the selected at least one image.

According to an embodiment of the disclosure, a non-transitory computer-readable recording medium may have recorded thereon a program for performing any one method of the disclosure in a computer.

Various embodiments of the disclosure may be implemented or supported by one or more computer programs, and the computer programs may be formed from computer-readable program code and may be included in a computer-readable medium. In the disclosure, the terms “application” and “program” may refer to one or more computer programs, software components, instruction sets, procedures, functions, objects, classes, instances, related data, or a portion thereof suitable for implementation in computer-readable program code. The “computer readable program code” may include various types of computer code including source code, object code, and executable code. The “computer-readable medium” may include various types of mediums accessible by a computer, such as ROMs, RAMs, hard disk drives (HDDs), CDs, DVDs, or various types of memories.

Also, the machine-readable storage medium may be provided in the form of a non-transitory storage medium. Here, the “non-transitory storage medium” may be a tangible device and may exclude wired, wireless, optical, or other communication links for transmitting temporary electrical or other signals. Moreover, the “non-transitory storage medium” may not distinguish between a case where data is semi-permanently stored in the storage medium and a case where data is temporarily stored therein. For example, the “non-transitory storage medium” may include a buffer in which data is temporarily stored. The computer-readable medium may be any available medium accessible by a computer and may include volatile or nonvolatile mediums and removable or non-removable mediums. The computer-readable medium may include a medium in which data may be permanently stored and a medium in which data may be stored and may be overwritten later, such as a rewritable optical disk or an erasable memory device.

According to an embodiment of the disclosure, the method according to various embodiments of the disclosure described herein may be included and provided in a computer program product. The computer program product may be traded as a product between a seller and a buyer. The computer program product may be distributed in the form of a machine-readable storage medium (e.g., a CD-ROM) or may be distributed (e.g., downloaded or uploaded) online through an application store or directly between two user devices. In the case of online distribution, at least a portion of the computer program product (e.g., a downloadable app) may be at least temporarily stored or temporarily generated in a machine-readable storage medium such as a manufacturer's server, a server of an application store, or a memory of a relay server.

The foregoing descriptions of the disclosure are merely examples, and those of ordinary skill in the art will readily understand that various modifications may be made therein without materially departing from the spirit or features of the disclosure. For example, suitable results may be achieved even when the described technologies are performed in a different order from the described method and/or the components of the described system, structure, apparatus, or circuit are coupled or combined in a different form from the described method or are replaced or substituted by other components or equivalents thereof. Therefore, it is to be understood that the embodiments of the disclosure described above should be considered in a descriptive sense only and not for purposes of limitation. For example, each component described as a single type may also be implemented in a distributed manner, and likewise, components described as being distributed may also be implemented in a combined form.

The scope of the disclosure is defined not by the above detailed description but by the following claims, and all modifications derived from the meaning and scope of the claims and equivalent concepts thereof should be construed as being included in the scope of the disclosure.

What is claimed is:

1. A method comprising:
obtaining a plurality of images each comprising an image of a plurality of persons;
identifying one image among the plurality of images as a base image;
identifying a source image among the plurality of images based on a completion level of each of the plurality of images other than the base image and a swap compatibility of each of the plurality of images other than the base image;
extracting a face region of a person among the plurality of persons from the source image; and
generating a correction image by compositing the extracted face region on the base image,
wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

2. The method of claim 1, wherein the plurality of images comprise images continuously captured over a set period of time.

3. The method of claim 1, wherein the identifying one image among the plurality of images as the base image comprises:
obtaining, with respect to each of the plurality of images, a first aesthetic score by numerically quantifying the completion level;
obtaining, with respect to an image pair comprising two images of the plurality of images, a first compatibility score by numerically quantifying a swap compatibility between a face region of the image of the person in each image of the image pair; and
identifying one image among the plurality of images as the base image based on the first aesthetic score and the first compatibility score.

4. The method of claim 1, wherein the identifying the source image comprises:
obtaining, with respect to each of the plurality of images, a second aesthetic score by numerically quantifying the completion level;
obtaining, with respect to each of the plurality of images, a second compatibility score by numerically quantifying the swap compatibility; and
identifying the source image based on the second aesthetic score and the second compatibility score.

5. The method of claim 4, wherein the obtaining the second aesthetic score comprises:
obtaining a plurality of first person images each comprising an image of the person;
extracting a preference for the person from the plurality of first person images; and
determining the second aesthetic score based on the preference for the person.

6. The method of claim 5, wherein the preference for the person is determined based on at least one of a facial expression of the person, clothing worn by the person, a hairstyle of the person, an eye blink of the person, a head pose of the person, a hand pose of the person, or an occlusion of the person.

7. The method of claim 4, wherein the obtaining, with respect to each of the plurality of images, the second compatibility score comprises:
extracting from the base image a base feature point related to a position of a body of the person;
extracting from each of the plurality of images other than the base image a target feature point related to the position of the body of the person; and
determining the second compatibility score for each of the plurality of images other than the base image by comparing the base feature point with each extracted target feature point.

8. The method of claim 1, wherein the correction image comprises an image in which the face region of the image of the person in the base image is replaced with the extracted face region.

9. The method of claim 1, further comprising:
obtaining a degree of blurriness of each of the plurality of images; and
selecting, from among the plurality of images, at least one image of which the degree of blurriness does not exceed a threshold,
wherein the identifying one image among the plurality of images as the base image comprises identifying the base image from among the selected at least one image, and
wherein the identifying the source image comprises identifying the source image from among the selected at least one image.

10. The method of claim 1, wherein the generating the correction image further comprises:
generating a three-dimensional (3D) face model of the person based on a plurality of first person images each comprising an image of the person;
correcting the extracted face region based on the 3D face model; and
generating the correction image by compositing the corrected face region on the base image.

11. An electronic device comprising:
an input/output interface configured to receive a user input requesting processing of an image and to output an image processed according to the user input;
at least one memory storing one or more instructions; and
at least one processor configured to execute the one or more instructions, wherein the one or more instructions, when executed by the at least one processor, cause the electronic device to:
obtain a plurality of images each comprising an image of a plurality of persons,
identify one image among the plurality of images as a base image,
identify a source image among the plurality of images based on a completion level of each of the plurality of images other than the base image, and a swap compatibility of each of the plurality of images other than the base image,
extract a face region of a person among the plurality of persons from the source image, and
generate a correction image by compositing the extracted face region on the base image,
wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.

12. The electronic device of claim 11, wherein the plurality of images comprise images continuously captured over a set period of time.

13. The electronic device of claim 11, wherein the one or more instructions, when executed by the at least one processor, cause the electronic device to:
obtain, with respect to each of the plurality of images, a first aesthetic score by numerically quantifying the completion level,
obtain, with respect to an image pair comprising two images of the plurality of images, a first compatibility score by numerically quantifying a swap compatibility between a face region of the image of the person in each image of the image pair, and
identify one image among the plurality of images as the base image based on the first aesthetic score and the first compatibility score.

14. The electronic device of claim 11, wherein the one or more instructions, when executed by the at least one processor, cause the electronic device to:
obtain, with respect to each of the plurality of images, a second aesthetic score by numerically quantifying the completion level,
obtain, with respect to each of the plurality of images, a second compatibility score by numerically quantifying the swap compatibility, and
identify the source image based on the second aesthetic score and the second compatibility score.

15. The electronic device of claim 14, wherein the one or more instructions, when executed by the at least one processor, cause the electronic device to:
obtain a plurality of first person images each comprising an image of the person,
extract a preference for the person from the plurality of first person images, and
determine the second aesthetic score based on the preference for the person.

16. The electronic device of claim 14, wherein the one or more instructions, when executed by the at least one processor, cause the electronic device to, in obtaining the second compatibility score:
extract from the base image a base feature point related to a position of a body of the person,
extract from each of the plurality of images other than the base image a target feature point related to the position of the body of the person, and
determine the second compatibility score for each of the plurality of images other than the base image comparing the base feature point with each extracted target feature point.

17. The electronic device of claim 11, wherein the correction image comprises an image in which the face region of the image of the person in the base image is replaced with the extracted face region.

18. The electronic device of claim 11, wherein the one or more instructions, when executed by the at least one processor, cause the electronic device to:
obtain a degree of blurriness of each of the plurality of images,
select, from among the plurality of images, at least one image of which the degree of blurriness does not exceed a threshold,
identify the base image from among the selected at least one image, and
identify the source image from among the selected at least one image.

19. The electronic device of claim 11, wherein the one or more instructions, when executed by the at least one processor, cause the electronic device to, in generating the correction image:
generate a three-dimensional (3D) face model of the person based on a plurality of first person images each comprising an image of the person,
correct the extracted face region based on the 3D face model, and
generate the correction image by compositing the corrected face region on the base image.

20. A non-transitory computer readable medium having instructions stored therein, which when executed by at least one processor cause the at least one processor to execute a method comprising:
obtaining a plurality of images each comprising an image of a person;
identifying one image among the plurality of images as a base image;
identifying a source image among the plurality of images based on a completion level of each of the plurality of images other than the base image and a swap compatibility of each of the plurality of images other than the base image;
extracting a face region of the person from the source image; and
generating a correction image by compositing the extracted face region on the base image,
wherein, for each respective image of the plurality of images, the completion level comprises a completion level of shooting a face region of the image of the person in the respective image, and the swap compatibility comprises a swap compatibility between a face region of the image of the person in the base image and the face region of the image of the person in the respective image.
